(19) United States
(12) Patent Application Publication
(10) Pub. No.: US 2008/0051070 A1
(43) Pub. Date: Feb. 28, 2008

(54) Method and Apparatus for Alternate Content Recording and Reporting for Mobile Devices

(76) Inventor: Srinivasa Dharmaji, Sunnyvale, CA (US)

Correspondence Address: GLENN PATENT GROUP, 3475 EDISON WAY, SUITE L, MENLO PARK, CA, 94025, US

(21) Appl. No.: 11/842,598

(22) Filed: Aug. 21, 2007

Related U.S. Application Data
(63) Continuation-in-part of application No. 11/828,204, filed on Jul. 25, 2007.
(60) Provisional application No. 60/823,658, filed on Aug. 27, 2006.
(60) Provisional application No. 60/823,120, filed on Aug. 22, 2006.

(51) Int. Cl. H04Q 7/20

(52) U.S. Cl. 455/414.1

(57) ABSTRACT

Use of alternate digital content in connection with mobile devices is recorded and reported. An exemplary embodiment comprises an alternate content reporter module on the mobile device that works alongside an alternate content scheduler and a micro-splicer. The alternate content reporter also comprises a mobile network interface for interaction with a mobile data and broadcast network, an alternate content scheduler interface for enabling the recording of consumption and interruptions in consumption, a rulebook that provides rules for alternate content reporting, and a preference provisioning module comprising an alternate content reporter library for storing network preferences for reporting to access networks.

### CROSS REFERENCE TO RELATED APPLICATIONS

This application is a continuation-in-part of copending U.S. patent application Ser. No. 11/828,204, entitled Micro-Splicer for Inserting Alternate Content to a Content Stream on a Handheld Device, assigned to a common assignee and which is hereby incorporated by reference for all that it contains. This application also claims priority from U.S. provisional patent application Ser. No. 60/823,658, filed Aug. 27, 2006, entitled Alternate Content Recording and Reporting Mobile Devices, which is hereby incorporated by reference for all that it contains. This application also claims priority from U.S. provisional patent application Ser. No. 60/823,120, filed Aug. 22, 2006, entitled Alternate content scheduling on mobile devices, which is hereby incorporated by reference for all that it contains.

### BACKGROUND OF THE INVENTION

1. Technical Field

The invention generally relates to the providing of content to a mobile device and, more specifically, to the recording and reporting of alternate content targeted for a mobile device.

2. Description of the Prior Art

The availability and growth of use of handheld, portable, mobile devices, such as the personal digital assistant (PDA) and the cell phone, generally referred to herein as handheld devices, is revolutionizing the digital multimedia content viewing experience of individuals. Because each handheld device is specific to an individual, it is possible to personalize and focus advertisements, and other alternate content, to specific individual, or groups of individuals, having targeted characteristics. Ideally, the advertisement for each individual should be tailored, or otherwise targeted, to fit the specific requirements of that specific individual. Therefore, it would be necessary to provide each individual with a specific advertising stream.

One problem that exists today in implementing such a scheme is that there is limited bandwidth available in systems, such as a point-to-point or multicast wireless broadcasting of digital multimedia content. Therefore, it is impractical to provide each individual with a specifically targeted stream that fits that individual's characteristics. This limits the possibility to include focused advertisements and alternate content that are targeted towards specific individuals or groups. This is due to the fact that there are a substantial number of focused advertisements that must be broadcast simultaneously to achieve the objective of focused advertising. In addition, there must be the added capability at each handheld device to identify and view the alternate content or advertisement that is specifically meant for that individual. Hence, even though the idea of providing focused advertisements and alternate content to target groups has been a desirable concept in the advertising to customers using handheld devices, it has not been possible to implement this efficiently. Therefore, the current practice for inserting advertisements for viewing on handheld devices is to insert them into the content stream by splicing the advertisement either by altering the stream or prior to a multicast transmission.

Clearly, there are many mobile applications that can benefit from dynamic addressable alternate content insertion and it would be therefore advantageous to provide subsequent reporting of actual viewer-ship of such content. It would be further advantageous for mobile device based alternate content recording and reporting to determine the content consumption patterns of subscribers for popular applications such as Mobile TV, and to generate meaningful statistics on content patronage. It would be further advantageous if such alternate content reporting can be used for business model validation and service level agreement (SLA) verification between alternate content owners and mobile service providers. Such alternate content reporting would also help mobile service providers to calculate return-on-investment (ROI) by eliminating conventional metering techniques that are currently used to arrive at viewer-ship reports and by also eliminating the cost per bit incurred in delivering the service.

### SUMMARY OF THE INVENTION

A method and apparatus for recording and reporting alternate digital content use from mobile devices comprises an alternate content reporter module on the mobile device that works alongside an alternate content scheduler and a micro-splicer. The alternate content reporter further comprises a mobile network interface for interaction with a mobile data and broadcast network, an alternate content scheduler interface for enabling the recording of consumption and interruptions in consumption of content, a rulebook that provides the rules for alternate content reporting, and a preference provisioning module comprising an alternate content reporter library for storing network preferences of reporting access networks.

The invention may be used as the basis for generating in-depth reports based on alternate content viewer-ship. Examples of alternate content are advertisements, preferential content, emergency notifications, public broadcast announcements, storefront items, etc. The embodiments described herein explain the metadata specifications for viewer-ship reporting. Also described herein are different transport mechanisms and scenarios to deliver the reporting metadata to the network.

Alternate content can be streamed through transport mechanisms, such as cellular data networks, wireless fidelity (WiFi) networks, or any mobile device input or output (I/O) mechanism, and synchronized at the mobile terminal. The alternate content reporter aggregates all recording and reporting activities in conjunction with the alternate content scheduler. U.S. patent application Ser. No. 11/828,204, entitled Micro-Splicer for Inserting Alternate Content to a Content Stream on a Handheld Device, and U.S. patent application Ser. No. TBD, entitled Alternate Content Scheduling on Mobile Devices, both of which are assigned to a common assignee, and which are hereby incorporated by reference for all that they respectively contain, illustrate a method of inserting alternate digital content into multimedia content broadcast to mobile portable devices with tight synchronization and tandem functioning of a micro-splicer with the alternate content scheduler.

To support alternate content reporting, the invention uses the service of cellular data networks, mobile access networks, or other mechanisms that are entitled to provide input or output (I/O) to mobile equipment. To achieve the objective of alternate content reporting, the alternate content reporter works in conformity with the principles or conditions defined by the mobile network operator.

One embodiment of the invention reports advertisements consumed on the mobile device. Advertisements are transmitted and stored in the mobile device based on addressable factors, such as demographics, related program content, alternate content priorities, and ratings.

Another embodiment of the invention reports preferential content consumption instead of regular program content, based on subscriber choices on the mobile device. Consumption of content obtained through alternate transport channels or residing on the mobile device is reported, based on subscriber preferences.

Another embodiment of the invention reports the reach of public broadcast announcements in place of regular program content, with appropriate metadata interactions. Emergency notifications are another form of forced alternate content that is inserted into the user display by network scheduled high priority content delivery, and reporting of viewer-ship is important for reliably assessing the reach of such high priority content.

Another embodiment of invention reports the click through rate (CTR) of the user arising out of subscriber interactions with interactive segments of advertising or alternate content. The alternate content reporter in tandem with the alternate content scheduler and micro-splicer records these click through actions for reporting to the network.

### BRIEF DESCRIPTION OF THE DRAWINGS

FIG. 1 illustrates the entities involved in alternate content reporting according to the invention;

FIG. 2 illustrates a reporting rulebook transport for a single frequency network according to the invention;

FIG. 3 illustrates a geography-based rulebook for alternate content reporting according to the invention;

FIG. 4 illustrates a typical scenario for alternate content consumption recording according to the invention;

FIG. 5 illustrates an alternate content consumption recording scenario for application termination according to the invention;

FIG. 6 illustrates an alternate content consumption recording scenario for short interrupt according to the invention;

FIG. 7 illustrates an alternate content consumption recording scenario long interrupt according to the invention;

FIG. 8 illustrates an alternate content consumption reporting scenario in which a mobile device is initiated according to the invention; and

FIG. 9 illustrates an alternate content consumption reporting in which a network is initiated according to the invention.

### DETAILED DESCRIPTION OF THE INVENTION

A method and apparatus for recording and reporting alternate digital content from mobile devices comprises an alternate content reporter module on the mobile device that works alongside an alternate content scheduler and a micro-splicer. The alternate content reporter further comprises a mobile network interface for interaction with a mobile data and broadcast network, an alternate content scheduler interface for enabling the recording of consumption and interruptions in consumption, a rulebook that provides the rules for alternate content reporting, and a preference provisioning module comprising an alternate content reporter library for storing network preferences of reporting access networks.

Alternate content reporting comprises use of a shared reporting rulebook between the network and the mobile device, mobile access network interfaces for reporting the data to the network, preference provisioning for usage of appropriate access network for reporting, an alternate content scheduler interface for recording usage, and an interface to a local file system for storing the metrics in a metadata format specified in the rulebook.

The reporting rulebook comprises a protocol between the reporting network element and the mobile device for enforcing a policy or rule based alternate content reporting. In the presently preferred embodiment of the invention, the rulebook comprises is a schema, e.g. an XML-like schema, that denotes the categories of alternate content available for selection, mandatory categories, if any, association between categories and channels in the Mobile TV service, the duration of alternate content, the type of alternate content insertion, sub-categories, if any, etc.

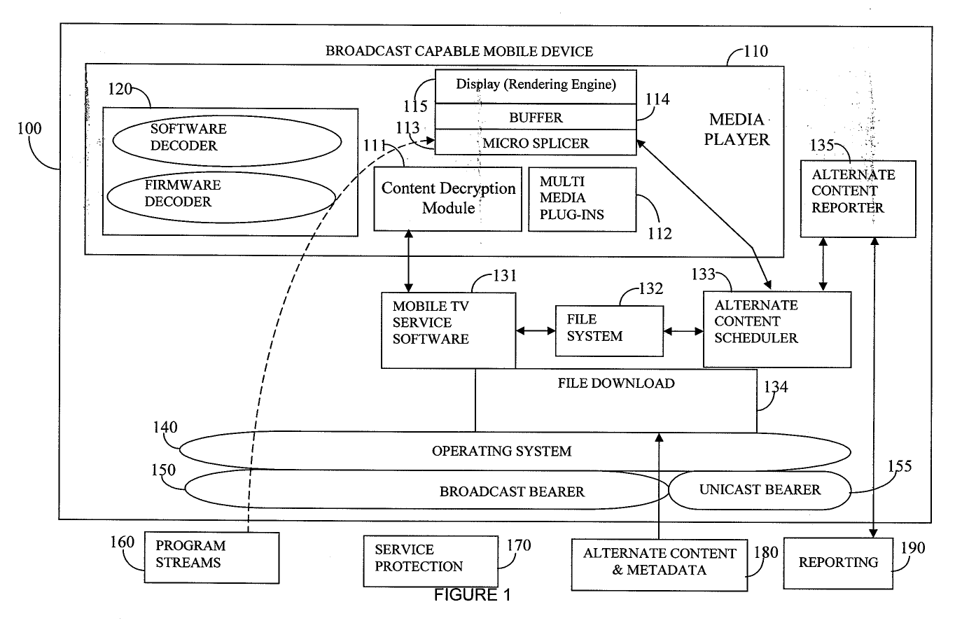

FIG. 1 illustrates the alternate content reporting components in a presently preferred embodiment of the invention. Such arrangement is exemplary and not limiting in connection with the invention. A system 100 for recording and reporting alternate digital content is inserted into mobile devices and comprises an alternate content scheduler 133, an alternate content reporter 135, and a micro-splicer 113. The alternate content reporter 135 has multiple management and storage functions which include, but are not limited to, interactions with the network for rulebook reporting metadata, which interactions are shared with the corresponding network element in the service provider network. The reporting rulebook varies depending on the network topology employed in mobile broadcast TV deployment. The alternate content scheduler 133 receives alternate content and related metadata over mobile operator provisioned transport network. The alternate content scheduler 133 helps synchronize content switching on the mobile device by notifying the micro-splicer 113 of the impending spot break, program switch, inlay, or overlay command for inserting alternate multimedia content. The alternate content reporter 135 is a module on the mobile device that is responsible for recording and reporting alternate content viewer-ship. The alternate content scheduler 233 interacts with the reporter 235 through an internal interface. Components not described herein and not necessary to understand in greater detail to understand and practice the invention herein are explained with reference to similar figures in U.S. patent application Ser. No. 11/828,204, entitled Micro-Splicer for Inserting Alternate Content to a Content Stream on a Handheld Device, and U.S. patent application Ser. No. TBD, entitled Alternate Content Scheduling on Mobile Devices, both of which are assigned to a common assignee, and which are both hereby incorporated by reference for all that they respectively contain.

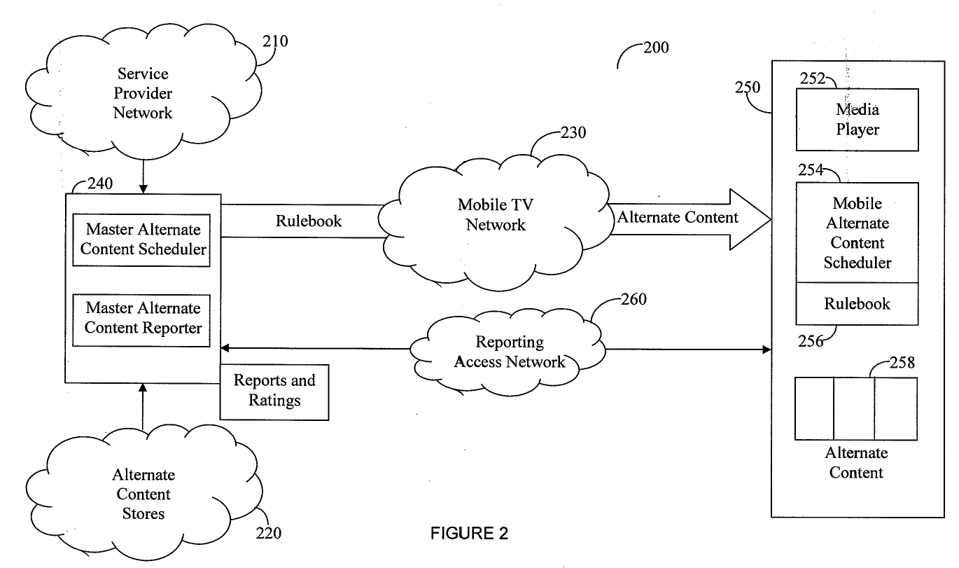

FIG. 2 illustrates a generic content reporting system 200 in an exemplary and non-limiting vanilla mobile TV network 230. FIG. 2 describes the insertion and reporting rulebooks which are transported over a mobile TV content delivery network 230 in a single frequency network (SFN) and which are stored on the mobile device 250. The alternate content reporter on the mobile device 250 reports content consumption data per rules defined in the rulebook 256.

This data from the mobile device 250 is aggregated in the master alternate content reporter of device 240 in the network and is used for generating reports and ratings of all relevant content viewer-ship.

Differentiated Content Reporting

Differentiated content reporting involves distributed alternate content reporters feeding back information on generic content to the master alternate content reporter of device 240 to be aggregated, and which is used for reporting and rating purposes. In addition, geographic specific content can be inserted into broadcast network topologies, such as multi frequency networks (MFN), at the regional or local alternate content schedulers. Reports of data associated with content inserted at such local scheduling centers are not sent to the master alternate content scheduler of device 240. Rather, they are aggregated into the local alternate content reporting centers. Such local/regional/geography specific reports and ratings are generated in the local alternate content reporters.

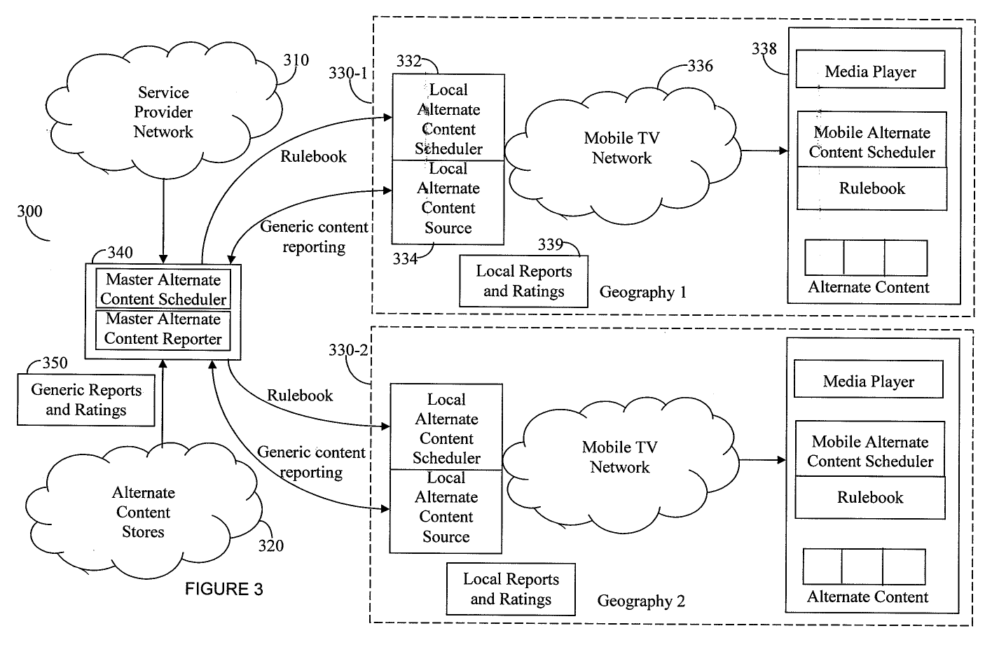

FIG. 3 shows the distributed management of differentiated content at master and local scheduling centers. All reporting from a mobile device 338 in this broadcast network topology happens in the local reporting centers 339. The master alternate content reporter of device 340 is connected to these local scheduling centers 332. Local reports 339 are generated in the local scheduling centers 332, while reports of generic alternate content 350 viewer-ship are generated at master scheduling centers 340.

Recording Viewer-Ship of Alternate Content

Viewer-ship recording n accordance with the invention can be accomplished in any of multiple ways. Category and preference based collection of data on the mobile device are useful collection tools because they correspond one-on-one with the different provisioning mechanisms for inserting addressable content.

All data are stored locally in the mobile operator allocated storage on the mobile device. Once the report is delivered to the network, the data on the mobile device is erased and the device is prepared for the next set of insertions.

Category Based Recording

Category based reporting is helpful for network operator's choice of category based alternate content insertion. Based on the subscription profile, demography, and other important criteria, the network operator sets the rules in the network which are executed by the mobile device. Typical of this type of viewer-ship data is:

Single Alternate Content Insertion Data Recording:
Alternate_Content_Category-ID=N
Alternate-Content_Sub-category-ID=n
Program Content or Channel ID=K
Date=04/13/1970
Start Time=9:20:22 GMT
End Time=9:20:31 GMT
Insertion Type: Interstitial
Interruptions=NONE

Aggregation of the individual insertion data happens on the mobile device before reporting to the network. Optimization of reporting data is important to conserve network bandwidth. A typical category based report delivered to the network appears as:

Reporting-subid-cellid-date.xml
Subscriber ID: XYZ
Cell Sector ID: 1234
Report Type: Category
Access Network: HSDPA
Reporting protocol: HTTPS
Reporting URL: https://region1.serviceprovider.example.com
Date and Time: 04/13/1970, 02:22:21 GMT
Alternate_Content_Category X:
   Total Insertions: 42
   Alternate_Content_Sub-category X1: 22
      Insertion Type: Bumper-2, Interstitial-6, Gateway-10, Overlay-2, Forced-2
      Insertion Times: Channel K1 (Time1-Time2), Channel K2 (Time3-Time4)
      Interruptions: 1 (K2, Time1-Time2, 4 seconds)
   Alternate_Content_Sub-category X2: 20
      Insertion Type: Bumper-2, Interstitial-6, Gateway-8, Overlay-2, Forced-2
      Insertion Times: Channel K1 (Time1-Time2), Channel K2 (Time3-Time4)
      Interruptions: 1 (Channel K2, Time3-Time4, 4 seconds)
Alternate_Content_Category Y:
Total Insertions: 25

Preference Based Recording

Preference based provisioning is different than category based provisioning in the following ways:

1. Users can dynamically change preferences; and,

2. Associate preference with program channels

The reports in this case are based on the program channels into which alternate content is inserted. Typical of a single insertion is:

Single Preference Based Alternate Content Insertion Data Recording:
Program Content Channel or ID: K
User preference: Alternate_Content_Category-ID-N
Inserted alternate content: Alternate-Content_Sub-category-ID-n
Date=04/13/1970
Start Time=9:20:22 GMT
End Time 9:20:31 GMT
Insertion Type: Interstitial
Interruptions=NONE

A preference-based report delivered to the network appears as follows:

Reporting-subid-cellid-date.xml
Subscriber ID: XYZ
Report type: Preference based
Cell Sector ID: 1234
Access Network: WiFi (802.11)
Reporting protocol: HTTPS
Reporting URL: https://region1.serviceprovider.example.com
Date and Time: 04/13/1970, 02:22:21 GMT
Program Channel: K1
   Total Insertions: 47
User Preference: Alternate_Content_Category_X1
   Insertions: 22
      Sub-categories: X12 (4), X13 (6), X14 (12)
      Insertion Type: Bumper-2, Interstitial-6, Gateway-10, Overlay-2, Forced-2
      Insertion Times: (Time1-Time2), 5 (Time3-Time4) etc.
      Interruptions: 0
User Preference: Alternate_Content_Category_X2
Insertions: 25
   Sub-categories: X22 (4), X23 (6), X24 (12), X25 (3)
   Insertion Type: Bumper-2, Interstitial-6, Gateway-8, Overlay-2, Forced-7
      Insertion Times: (Time1-Time2), (Time3-Time4), etc.
      Interruptions: 1 (Time3-Time4, 4 seconds)
Program Channel: K2
User Preference: Alternate_Content_Category_Y

The message flows described below illustrate the message flows for viewer-ship recording and reporting on the mobile device. Following are general assumptions for these message flows:
Software libraries for alternate content scheduling and reporting, along with the micro-splicer plug-in to the media player, are installed on the mobile device.
Mobile TV service delivery software is installed and enabled on the mobile device.
Alternate content is stored on the handset though mobile operators specified content delivery channels.
A rulebook for insertions and reporting of alternate content is available to the respective components on the mobile device.
Storage of viewer-ship metadata is provisioned on the mobile device.

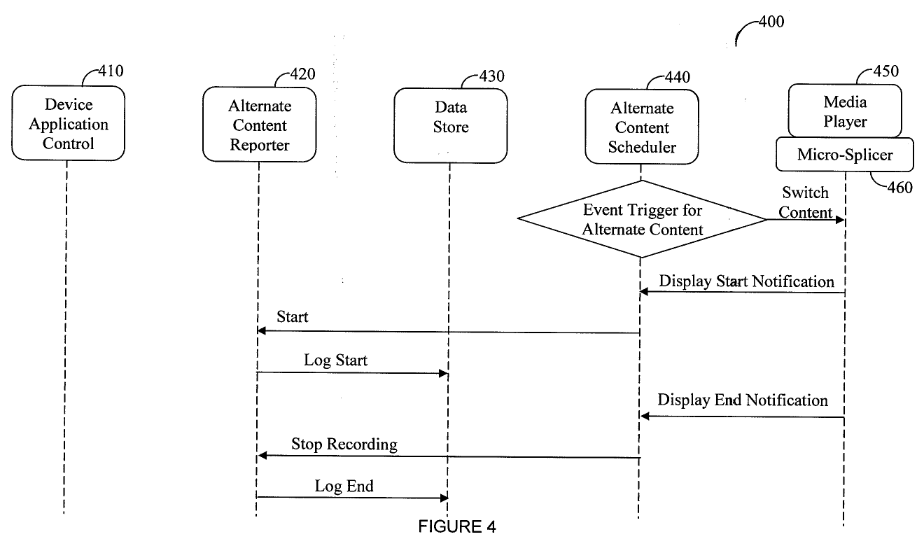

FIG. 4 is a diagram 400 that shows the normal recording of alternate content metadata viewed on the mobile device by the subscriber. The following takes place:
Program content is rendered on the mobile device 450;
Event trigger on the alternate content scheduler 440 happens;
The alternate content scheduler 440 notifies the micro-splicer 460 to switch;
The micro-splicer notifies the scheduler 440 of the start of alternate content display;
The scheduler 440 issues a start recording command to the reporter 420, along with requisite metadata;
The reporter 420 logs the start of insertion along with associated metadata;
The micro-splicer 460 notifies the scheduler 440 of the end of display;
The scheduler 440 issues a stop recording command to the reporter 420; and
The reporter 420 logs the end of insertion in the file on the local data store 430.

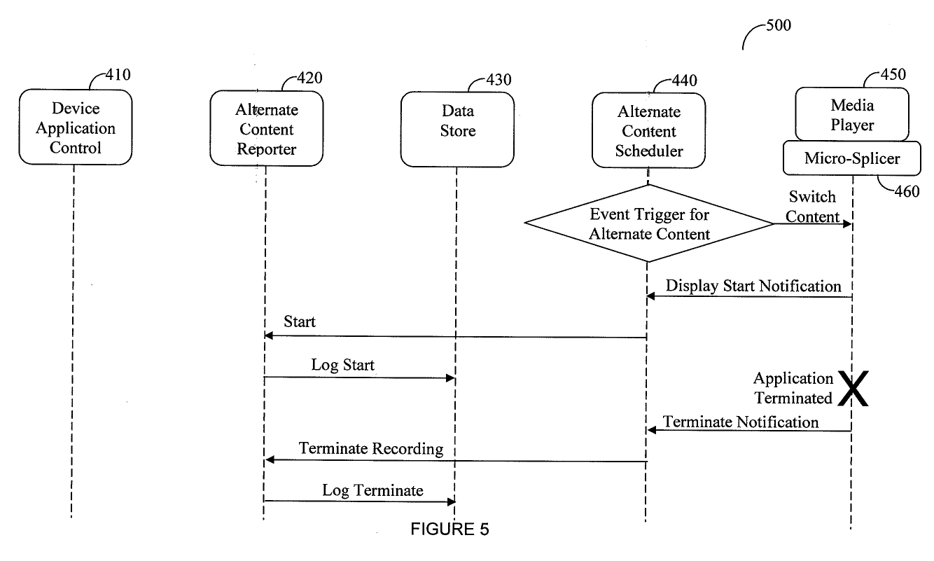

FIG. 5 is a diagram 500 of the recording of alternate content viewer-ship when the application terminates during rendering of alternate content is shown. The following takes place:
Program content is rendered on the mobile device 450;
Event trigger on the alternate content scheduler 440 happens;
The alternate content scheduler 440 notifies the micro-splicer 460 to switch content;
The micro-splicer 460 notifies the scheduler 440 of the start of alternate content display;
The scheduler 440 issues a start recording command to the reporter 420, along with requisite metadata;
The reporter 420 logs the start of insertion, along with associated metadata;
A Mobile TV service application is terminated by the user;
The micro-splicer 460 notifies the scheduler of application termination;
The scheduler 440 issues a terminate recording command to the reporter 420; and
The reporter 420 logs termination of insertion in the file on the local data store 430.

Interruption Recording and Reporting

Because the mobile device has many applications and functions, the priority of the application is controlled by the mobile device application controller. An event trigger of a higher priority, such as a voice call or a messaging application, interrupts the content viewed on the device. It is important to record these interruptions to allow the exact content viewer-ship to be recorded on the mobile device and conveyed to the network. There are many types of interrupts, but typically there are short and long interrupts. The alternate content scheduler 440, the reporter 420, and the micro-splicer 460 work in tandem to ensure a good user experience when the user switches back to the mobile TV application that is running in the background.

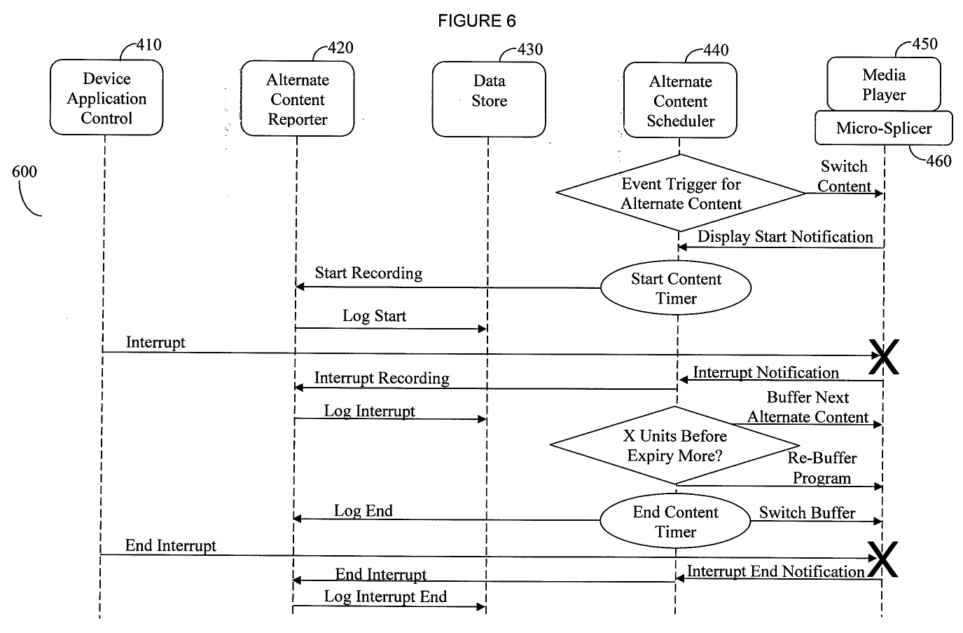

FIG. 6 is a diagram 600 that explains the message flow for short interrupts that are very brief and that do not last the entire duration of alternate content insertion. The following takes place:
Program content is being rendered on the mobile device 450;
Event trigger on the alternate content scheduler 440 happens;
The alternate content scheduler 440 notifies the micro-splicer 460 to switch content;
The micro-splicer 460 notifies the scheduler 440 of the start of alternate content display;
The scheduler 440 starts a timer for the duration of the alternate content inserted;
The scheduler 440 issues a start recording command to the reporter 420 along with requisite metadata;
The reporter 420 logs the start of insertion along with associated metadata;
A Mobile TV service application is interrupted by the device controller by sending an interrupt to the media player 450;
The micro-splicer 460 notifies scheduler 440 of the start of interrupt;
The scheduler 440 issues a interrupt recording command to the reporter 420;
The reporter 420 logs start of interrupt of in the file on the local data store 430;
The device controller sends an end interrupt instruction to the media player 450;
The micro-splicer 460 sends an interrupt end notification to the scheduler 440;
The scheduler 440 sends an interrupt end command to the reporter 420;
The reporter 420 logs interrupt end/restart recording in the data store 430;
An alternate content timer on the scheduler 440 expires, resulting in notification to the micro-splicer 460 to switch the buffer and to send an end recording command to reporter 420; and
The reporter 420 logs the end of insertion in the local file of data store 430.

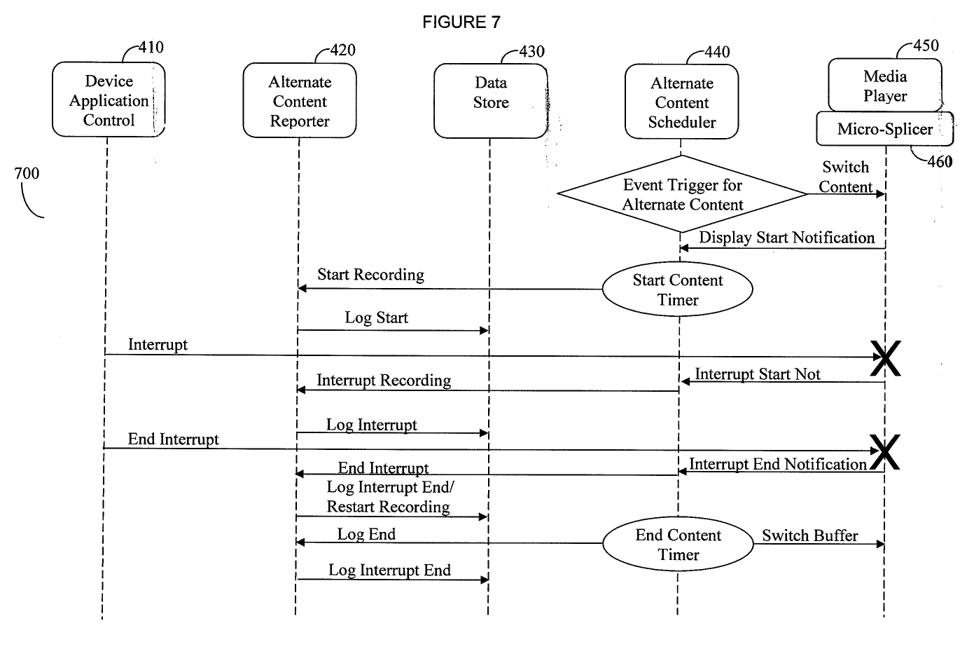

FIG. 7 is a diagram 700 that addresses the issue of handling long interrupts that are typically reminiscent of lengthy voice/messaging conversations that start during the rendering of alternate content on the mobile device. The service provider pre-configures the behavior of the Mobile TV application on the device. Typically, when an interrupt happens there are, at the minimum, two configurations possible on the mobile device:

1. The mobile device terminates the mobile TV application; and

2. The mobile TV application is held in the background without being terminated.

The message flows below, in conjunction with the illustration of FIG. 7, depict the later scenario, where the mobile TV application is held in the background during a long interrupt. In this embodiment, the following takes place:
Program content is being rendered on the mobile device;
Event trigger on the alternate content scheduler 440 happens
The alternate content scheduler 440 notifies the micro-splicer 460 to switch content;
The micro-splicer 460 notifies the scheduler 440 of the start of alternate content display;
The scheduler 440 starts a timer for the duration of the alternate content insertion;
The scheduler 440 issues a start recording command to the reporter 420, along with requisite metadata;
The reporter 420 logs into the data store 430 the start of insertion, along with associated metadata;
A Mobile TV service application is interrupted by the device controller;
The micro-splicer 460 notifies the scheduler 440 of the start of interrupt;
The scheduler 440 issues an interrupt recording command to the reporter 420;
The reporter 420 logs a start of interrupt in the file on the local data store 430;
X units before the expiry of the timer, the scheduler 440 checks for more alternate content to be inserted following the current content is interrupted;
The micro-splicer 460 restarts buffering original program content if no other alternate content needs to be displayed, else it buffers the next alternate content;
The alternate content timer on the scheduler 440 expires, resulting in notification to the micro-splicer 460 to switch the buffer and to send an end recording command to the reporter 420;
The device controller sends an end interrupt instruction to the media player 450;
The micro-splicer 460 sends an interrupt end notification to the scheduler 440;
The scheduler 440 sends an interrupt end command to the reporter 420;
The reporter 420 logs an interrupt end/restart recording in the file of the data store 430;
The reporter 420 logs an end of insertion in the local file of the data store 430; and
The recording for the next alternate content begins as described above.

Association with Alternate Content Metadata and Program Content Metadata

The reporting rulebook is associated with program metadata though metadata sharing with a rulebook. The functions of the rulebook are described in more detail in U.S. patent application Ser. No. 11/828,204, entitled Micro-Splicer for Inserting Alternate Content to a Content Stream on a Handheld Device, and U.S. patent application Ser. No. TBD, entitled Alternate Content Scheduling on Mobile Devices, both of which are assigned to a common assignee, and both of which are hereby incorporated by reference for all that they respectively contain.

The rulebooks for scheduling and reporting alternate content are shared to a great extent in terms of metadata descriptions and usage. The rulebook for reporting contains additional rules for reporting, such as the storage available on the mobile device, access network provisioning, regional/generic alternate content reporters, the order of contacting these distributed reporters, etc.

Provisioning Rules for Reporting

Provisioning of secure reporting is important to collect the viewer-ship data in the network and generate reports and ratings of content patronage by mobile subscribers. Provisioning of reporting involves describing the criteria, access network availability, cost of data transmission over mobile networks, load on the network elements aggregating the data, and connection and security management issues, among other things.

Following are some criteria that can be used by the service providers to provision the rules for the mobile devices to report the viewer-ship data:
Point-to-point connection when the reporting cache on the mobile device reaches its configured watermark;
Network initiated reporting, such as network initiated point-to-point SMS, SMS Cell broadcast, WAP push;
Reporting at a network provisioned constant time of the day, such as in the wee hours, when the load on mobile data networks is relatively low;
Instant reporting for emergency notifications, e.g. “How many users are currently watching forced alternate content?;”and
Reporting when non-cellular transport channels, such as Bluetooth or WiFi, are available.

Provisioning rules for reporting, including usage of access networks, takes the shape of either mobile device initiated reporting or network initiated reporting.

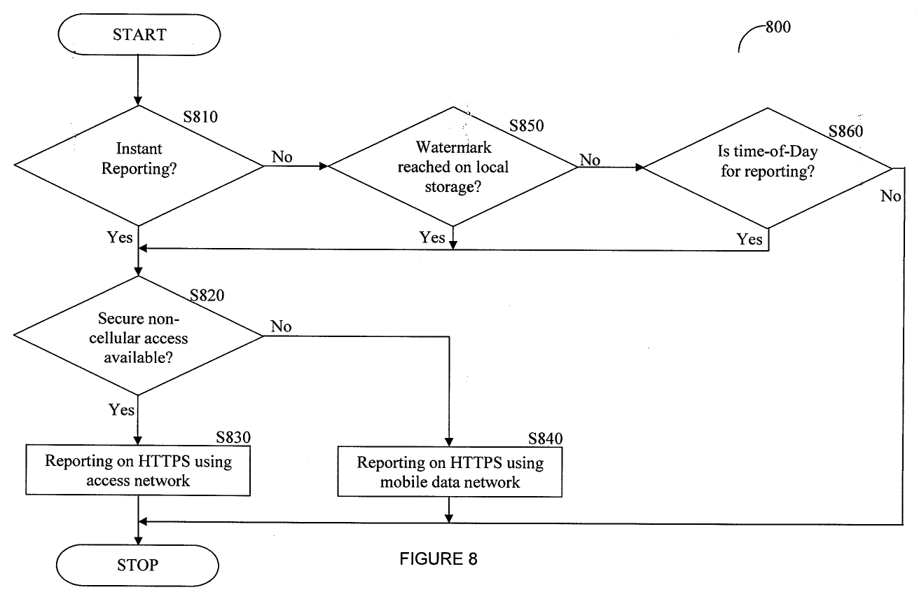

FIG. 8 depicts a decision tree 800 for reporting use of a mobile access network that is initiated by the mobile device. Network initiated reporting happens when the network initiates a request for reporting from all mobile clients in a cell sector or region for feedback on viewer-ship of particular alternate content that is inserted through the scheduler. In step S810, it is checked whether instant reporting is required and, if so, execution continues with step S820; otherwise, execution continues with step S850. In step S820, it is checked whether a secure non-cellular access is available and, if so, execution continues with step S830; otherwise, execution continues with step S840. In step S830, reporting is performed using a secure hypertext protocol (HTTPS) over an access network. In step S840, reporting is performed using HTTPS over a mobile data network. In step S850, it is determined whether the watermark was reached on local storage, i.e. a point where a report is to be generated and, if so, execution continues with step S820, as described above; otherwise, execution continues with step S860, where it is checked whether it is the time-of-day for reporting and, if so, execution continues with step S820; otherwise, execution terminates.

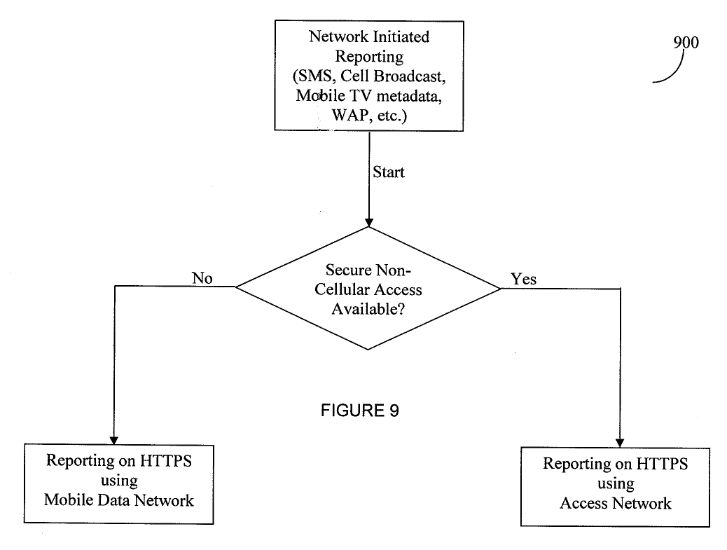

FIG. 9 shows a decision chart 900 that illustrates when the alternate content reporter receives a request from the network. The request 910 can be received in one or more of kinds of requests that include, but are not limited to, short message system (SMS), cell broadcast, metadata, such as those provided by a Mobile TV network, wireless application protocol (WAP), and the like. Based on the availability 920 of networks for secure transfer of the data over HTTPS, either the access network 930 or the mobile data network 940 may be used.

Optimizations and Enhancements

Alternate content reporting is extremely useful to obtain exact viewer-ship details of content on mobile devices. Reporting criteria vary with mobile TV network deployed. Optimizations and enhancements to the above-described mechanisms are necessary to adapt to these network conditions.

In summary, the invention reports advertisements consumed on the mobile device. Advertisements are transmitted and stored in the mobile device based on addressable factors, such as demographics, related program content, alternate content priorities, and ratings.

Another embodiment of the invention reports preferential content consumption, instead of regular program content, based on subscriber choices on the mobile device. Consumption of content obtained through alternate transport channels, or residing on the mobile device, is reported based on subscriber preferences.

Yet another embodiment of the invention reports the reach of public broadcast announcements, in place of regular program content, with appropriate metadata interactions. Emergency notifications are another form of forced alternate content that is inserted into the user display by network scheduled high priority content delivery, and reporting of viewer-ship is important for reliably assessing the reach of such high priority content.

A further embodiment of invention reports the click through rate (CTR) of the user arising out of subscriber interactions with interactive segments of advertising or alternate content. The alternate content reporter, in tandem with the alternate content scheduler and micro-splicer, records these click through actions for reporting to the network.

Although the invention is described herein with reference to the preferred embodiment, one skilled in the art will readily appreciate that other applications may be substituted for those set forth herein without departing from the spirit and scope of the invention. Accordingly, the invention should only be limited by the Claims included below.

1. An apparatus for reporting consumption of alternate digital content on a mobile device having a mobile network interface for interfacing with a mobile network, comprising:
an alternate content scheduler having an associated scheduler interface;
a micro-splicer having an associated micro-splicer interface;
a preference provisioning module comprising a library;
a reporter, working in tandem with said micro-splicer and said scheduler, for accurately recording and reporting the consumption of said alternate digital content by said mobile device; and
said micro-splicer and said scheduler comprising means for rendering a tightly synchronized display of multimedia content on said mobile device.

2. The apparatus of claim 1, wherein said mobile network comprises any of:
a mobile data network; and
a broadcast network.

3. The apparatus of claim 1, further comprising:
a rulebook comprising rules for alternate digital content scheduling.

4. The apparatus of claim 3, wherein said rules for alternate content comprise any of:
local rules; and
global rules.

5. The apparatus of claim 1, wherein said library comprises any of:
user preferences; and
network preferences.

6. The apparatus of claim 5, wherein said network preferences comprise any of:
local network preferences; and
global network preferences.

7. The apparatus of claim 1, said recorder comprising:
means for recording metrics regarding said alternate digital content.

8. The apparatus of claim 1, said means for rendering a tightly synchronized display comprising:
means for precise insertion of the alternate digital content at a desired spot break during display of original program content.

9. The apparatus of claim 8, said means for rendering a tightly synchronized display comprising:
means for precise return to said original program content from the alternate digital content.

10. The apparatus of claim 1, wherein said alternate digital content comprises any of:
local alternate content; and
global alternate content.

11. A method for recording and reporting use of alternate digital content by a mobile device, comprising the steps of:
receiving a trigger initiating the use of the alternate digital content;
causing a micro-splicer to switch the mobile device to display the alternate digital content;
notifying a start of the display of the alternate digital content by the mobile device; and
logging the start of the display of the alternate digital content into a log memory in response to the notifying of the start of the display of the alternate digital content.

12. The method of claim 11, further comprising the steps of:
notifying an end of the display of the alternate digital content; and
logging the end of the display of the alternate digital content into said log memory in response to the notifying of the end of the display of the alternate digital content.

13. The method of claim 11, further comprising the steps of:
receiving an application termination notification during the display of the alternate digital content; and
logging an application termination into said log memory in response to said receiving said application termination notification.

14. The method of claim 11, further comprising the steps of:
activating a timer;
receiving an end of timer notification from said timer during the display of the alternate digital content; and
logging the end of timer notification into said log memory in response to said receiving an end of timer notification from said timer.

15. The method of claim 11, further comprising the steps of:
receiving a beginning of interrupt notification;
logging the interrupt notification into said log memory in response to said receiving a beginning of interrupt notification; and
causing said micro-splicer to switch to a next alternate digital content in response to said interrupt notification.

16. The method of claim 15, further comprising the steps of:
receiving an end of interrupt notification; and
logging the end of interrupt notification into said log memory in response to said receiving said end of interrupt notification.

17. The method of claim 15, further comprising the steps of:
checking a predefined number of units prior to expiry; and
re-buffering a program the was originally displayed for the mobile device.

18. The method of claim 11, further comprising the step of:
reporting information logged into said log memory in response to a network initiated reporting request.

19. The method of claim 18, further comprising any of the steps of:
sending said information over an access network; and
sending said information over a mobile data network if said access network in unavailable.

20. The method of claim 19, wherein said information is transferred using a secured hypertext protocol (HTTPS).

21. The method of claim 18, wherein said reporting request is sent using any of:
SMS;
cell broadcast;
HTTP;
Mobile TV metadata; and
WAP.
